(19) United States
(12) Patent Application Publication
(10) Pub. No.: US 2025/0381471 A1
(43) Pub. Date: Dec. 18, 2025

(54) SENSOR-DRIVEN MOTION DETECTION FOR MOBILE DEVICES DURING TABLETOP GAMEPLAY

(71) Applicant: Hasbro, Inc., Pawtucket, RI (US)

(72) Inventors: Scott S. Clark, Barrington, RI (US); William McFadden, Stoughton, RI (US); David Derouin, Foxboro, MA (US)

(21) Appl. No.: 19/236,902

(22) Filed: Jun. 12, 2025

Related U.S. Application Data
(60) Provisional application No. 63/660,375, filed on Jun. 14, 2024.

(51) Int. Cl. A63F 13/211; A63F 13/52; A63F 13/56

(52) U.S. Cl. CPC A63F 13/211; A63F 13/52; A63F 13/56

(57) ABSTRACT

Disclosed herein are systems and associated methods for detecting the motion of a mobile device through sensors of the mobile device. The systems and methods include providing a mobile device with a velocity and a position on a flat surface, where the mobile device displays a game map. The system receives sensor data from one or more motion sensors of the mobile device. The system filters the sensor data to reduce noise and variability of the sensor data. The filtered sensor data is evaluated to determine linear acceleration and angular velocity of the mobile device. The system translates the linear acceleration and the angular velocity of the mobile device to a set of pixel movements of the game map, and displays the set of pixel movements of the game map on the mobile device.

### CROSS-REFERENCE TO RELATED APPLICATION(S)

This application claims priority to, and the benefit of, U.S. Provisional Patent Application Ser. No. 63/660,375 filed on Jun. 14, 2024, incorporated herein by reference in its entirety.

### BACKGROUND

Movement detection is used in various fields, such as robotics, gaming, and augmented reality (AR). Detecting movement can be performed by detecting and quantifying the movement of an object in space, which is typically achieved for devices through the use of cameras embedded in modern smartphones and other mobile devices. Movement detection using a camera includes capturing visual data from the environment and analyzing the visual data to determine changes in position, orientation, or other movement characteristics of objects within the camera's field of view. By processing the sequence of images captured by the camera, software algorithms can detect and track motion, recognize patterns, and identify specific objects. For example, optical flow is a method that calculates the motion of objects between consecutive frames by using the movement of pixels in the images. Feature-based tracking includes identifying and following distinct features or points within the image. The features can be corners, edges, or other recognizable patterns that remain consistent across frames. By tracking the movement of these features, the system can infer the overall movement of the object.

### BRIEF DESCRIPTION OF THE DRAWINGS

FIG. 1 is a diagrammatic view illustrating an example environment of sensor-driven motion detection for mobile devices during tabletop gameplay, in accordance with one or more embodiments.

FIG. 2 is a diagrammatic view illustrating an example environment of indicating characters or objects to be displayed on mobile devices during gameplay, in accordance with one or more embodiments.

FIG. 3 is a flowchart illustrating a method of detecting translation of a mobile device during tabletop gameplay, in accordance with one or more embodiments.

FIG. 4 is a block diagram illustrating an example computer system, in accordance with one or more embodiments.

### DETAILED DESCRIPTION

Motion detection enhances the immersive experience of games, and provides more intractability between the players and the virtual world. Using motion detection, games translate physical movements of the player into in-game actions and create a more engaging and intuitive user experience. Motion detection not only makes gameplay more dynamic and responsive but also enables new forms of interaction not possible with other input methods. For example, motion detection allows for precise control in action and sports games, where a player's physical movements directly influence the performance of the player's in-game avatar, making the experience more realistic and enjoyable. Additionally, motion detection opens up opportunities for innovative game mechanics and genres, such as augmented reality (AR) games, where players can interact with virtual objects overlaid on the real world.

Tracking the movement of mobile devices accurately is increasingly important in modern gaming and various other contexts. In gaming, precise movement detection enables more immersive and engaging experiences, allowing players to interact with the game environment in a natural and intuitive manner. For instance, motion-controlled games rely on the ability to detect subtle and rapid movements to provide real-time feedback and interaction, enhancing the overall gaming experience. Accurate movement tracking can transform the way players interact with games, making activities like navigating virtual worlds, aiming, and controlling characters feel more responsive and lifelike.

However, achieving precise and reliable movement detection for devices moving on a flat surface presents significant challenges. For example, traditional motion detection systems typically depend heavily on visual inputs from forward-facing or rear-facing cameras to track the position and movement of a device. In a scenario where the user input includes sliding the mobile device across a table the forward-facing camera cannot be used because it will be blinded against the table. Similarly, the screen-facing camera (front-facing camera, also sometimes referred to as “selfie camera”) points to the ceiling and will not function in all circumstances. While some ceilings include distinctive patterns, many are a solid color without recognizable features. Moreover, the reliance on cameras for movement detection introduces additional constraints related to continuous video feed processing, which drains the device's battery quickly and require substantial processing power. Without the cameras, the system is unable to detect the movement of a mobile device across a flat surface.

To address the limitations of traditional motion detection systems, the system detects and translates the linear movement of a mobile device on a flat surface, where the mobile device displays a game map, by integrating data from multiple motion sensors to calculate the device's movement on a flat surface. The system receives raw sensor data from sensors such as an accelerometer and/or gyroscope. The data is then calibrated to account for device-specific variations and filtered to remove noise and reduce variability. The filtered sensor data is analyzed to determine the device's linear acceleration and angular velocity of the device. The linear acceleration and the angular velocity is translated to a set of pixel movements on the game map. For example, to ensure smooth and realistic motion, the system applies a damping factor to the calculated velocity, simulating natural deceleration. The system adjusts the sensitivity of movement detection by setting a motion threshold, ensuring that only significant movements are registered. Additionally, the system limits the maximum acceleration (e.g., implements an acceleration threshold) detected to prevent erroneous readings due to sudden, intense movements. A debounce delay mechanism is implemented in some embodiments to filter out false or accidental movements during the initial phase and subsequent continuous movements.

In some embodiments, the system implements a cascading sensor strategy. At a decision point, the system evaluates the quality and reliability of the sensor data. If the data quality falls below a predefined threshold, the system dynamically switches to an alternative sensor or a combination of sensors to maintain accurate movement detection. The approach ensures consistent performance across different mobile devices, regardless of sensor quality variations. In some embodiments, the system includes a graphical user interface (GUI) that allows users to adjust predefined sensor parameters, such as motion speed, damping factor, motion threshold, maximum acceleration, and debounce delays. The customization ensures that the system is fine-tuned to meet specific user preferences or application requirements. The calculated translation data is stored in a database for further processing or real-time application.

The system addresses the challenges of detecting and translating the linear movement of mobile devices on a flat surface without relying on the cameras of the device by using built-in motion sensors. By using the device's internal accelerometers and gyroscopes, the system is able to accurately capture and interpret the device's movements by filtering and calibrating the sensor data to remove noise and reduce variability. Further, by dynamically evaluating the quality of sensor data and switching to alternative sensors when the quality of the sensor does not satisfy a threshold, the system maintains high accuracy even in the presence of subpar performance from particular sensors. Users can expect reliable movement detection regardless of the specific device they are using, which is particularly important for developers aiming to create widely accessible applications. Additionally, by applying a damping factor to the calculated velocity and setting motion thresholds, the system accurately replicates the feel of sliding a device across a surface on the virtual game map on the device. The implementation of debounce delays filters out false or accidental movements, ensuring that only intentional actions are registered. These features contribute to a smoother and more responsive user experience, reducing the frustration often associated with choppy or imprecise motion tracking.

While the present technology is described in detail for use with gameplay, the technology could be applied, with appropriate modifications, to improve the motion detection of other applications, making the technology a valuable tool for diverse applications beyond gameplay. The examples provided in this paragraph are intended as illustrative and are not limiting. Any other application or game referenced in this document, and many others unmentioned are equally appropriate after appropriate modifications.

The invention is implemented in numerous ways, including as a process; an apparatus; a system; a composition of matter; a computer program product embodied on a computer-readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description that references the accompanying figures follows. The scope of the invention is limited only by the claims and the invention encompasses numerous alternatives, modifications, and equivalents. Numerous specific details are set forth in the following description in order to provide a thorough understanding of the disclosure. These details are provided for the purpose of example and the invention may be practiced according to the claims without some or all of these specific details. For the purpose of clarity, technical material that is known in the technical fields related to the invention has not been described in detail so that the invention is not unnecessarily obscured.

### Sensor-Driven Motion Detection for Mobile Devices

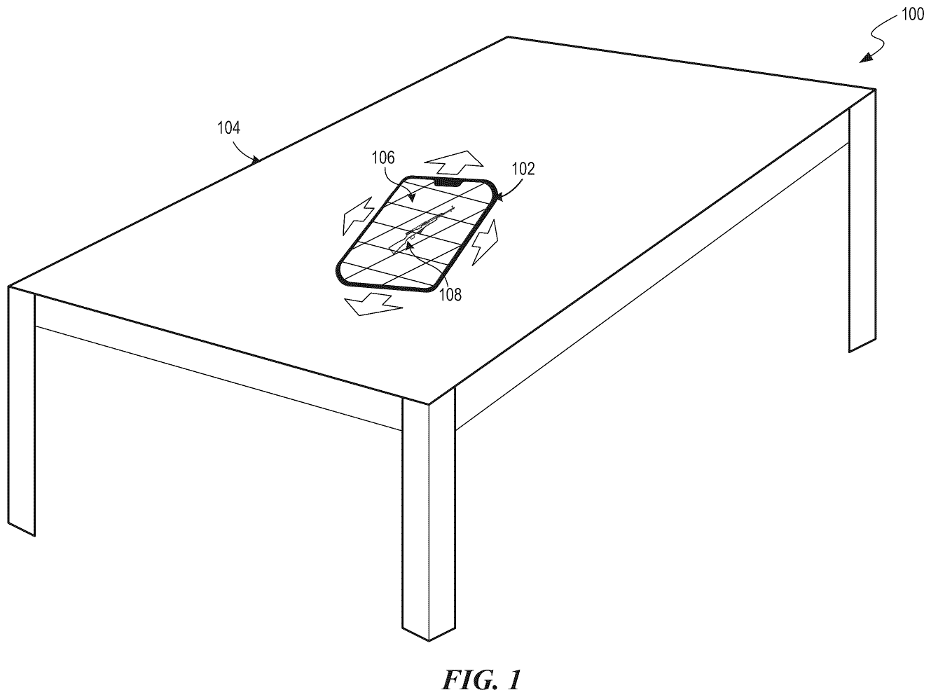

FIG. 1 is a diagrammatic view illustrating an example environment 100 of sensor-driven motion detection for mobile devices during tabletop gameplay, in accordance with one or more embodiments. Environment 100 includes a device 102, a flat surface 104, a game map 106, and a game interactive object 108. In some embodiments, implementations of example environment 100 include different and/or additional components or are connected in different ways.

Device 102 is a mobile computing device that features integrated motion sensors and a display screen. Examples include smartphones, tablets, and handheld gaming consoles. Device 102 is equipped with accelerometers, gyroscopes, and/or additional sensors like magnetometers and proximity sensors, allowing device 102 to accurately detect and measure movement. The display screen on the device 102 range from compact smartphone screens to larger tablet displays and provide a visual interface for interactive applications such as gaming applications. In some embodiments, device 102 includes computing devices capable of running gaming applications.

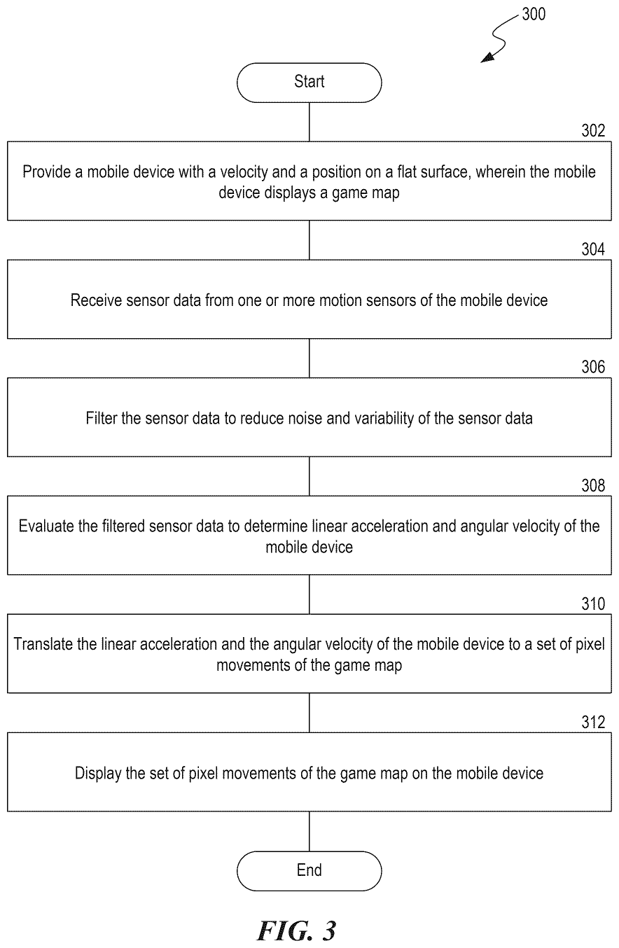

Device 102 is placed on a flat surface 104, which could be any smooth, horizontal area like a table or desk. Flat surface 104 provides an environment where the device 102 is able to move freely in multiple directions. The motion sensors of device 102, such as accelerometers and gyroscopes, enable device 102 to measure its movement across the flat surface 104. The game map 106 is displayed on the screen of the device 102, providing a visual representation of the game's virtual world. The map acts as the interface through which the player interacts with the game. As the device 102 moves on the flat surface 104, the motion sensors continuously collect data about the device's position and movement. The movements are detected and translated into corresponding movements on the game map 106. Methods of detecting and translating the corresponding movements on the game map are discussed with reference to FIG. 3. For instance, if the player slides the device to the right, the game map 106 shifts accordingly to show the new area that the player has moved into. The system calculates the velocity and position of the device 102, ensuring that the movement on the game map of the screen accurately reflects the physical movement of the device 102 on the flat surface.

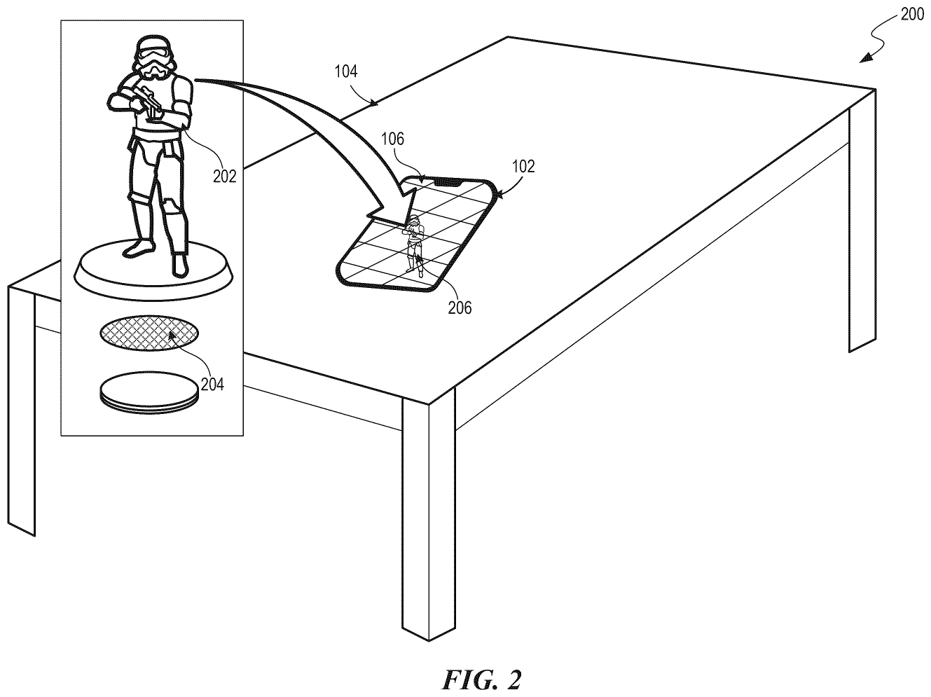

For example, the device 102 is used in a game that allows players to traverse the virtual landscape displayed on the device's 102 screen. Players control their in-game character by physically manipulating the mobile device 102 on the flat surface 104. As the device 102 is shifted along the tabletop surface (e.g., the flat surface 104), the game map follows suit, allowing players to explore different regions of the game map 106 and encounter various challenges and obstacles along the way. In some embodiments, the character's movements are slightly delayed. In some embodiments, the device 102 represents the perspective of a character a player is playing. For example, the character can be in the same position of the display screen of the device 102 (e.g., consistently in the bottom center of the screen). In some embodiments, a physical figurine of the character is used for login purposes to unlock the particular character. For example, players can use the figurine, equipped with an identifier such as an NFC tag, to authenticate and access the particular character's game profile by scanning the NFC tag with the device 102 (discussed further in FIG. 2).

The game interactive object 108 represents an element within the game that responds to the device's movements. For example, the game interactive object 108 includes objects such as a character, a vehicle, or any other entity that players control by physically moving the device 102. The interaction between the device 102 and the game map 106 is facilitated by the system's ability to accurately measure and emulate the device's real-world movements. This ensures that the virtual representation on the game map 106 follows the physical actions performed by the player, enhancing the realism and immersion of the gameplay experience. For example, if the interactive object 108 is a weapon, as the player slides device 102 on the flat surface 104, the interactive object 108 moves in accordance with the corresponding direction on the game map 106. For example, if the device 102 slides forward on the flat surface 104, the interactive object 108 slides backwards to simulate the user moving forward on the game map 106. Methods of detecting and translating movements of the device 102 are discussed with reference to FIG. 3.

By using the motion detection capabilities of the device 102 discussed in FIG. 3, the system provides a highly interactive and engaging tabletop gaming experience. Players are able to navigate the game map 106 by simply sliding the device 102 across the flat surface 104, with the movements being accurately mirrored in the game. The gameplay not only enhances the intuitive nature of the game but also eliminates the need for additional peripherals or controls (e.g., controllers, buttons), making the gameplay accessible and enjoyable for a wide range of users.

FIG. 2 is a diagrammatic view illustrating an example environment 200 of indicating characters or objects to be displayed on mobile devices during gameplay, in accordance with one or more embodiments. Environment 200 includes the device 102, the flat surface 104, the game map 106, a physical object 202, an NFC tag 204, and an NFC-connected virtual object 206. In some embodiments, implementations of example environment 200 include different and/or additional components or are connected in different ways.

The physical object 202 represents a tangible figurine, token, or collectible item that corresponds to a character, weapon, vehicle, or other game element within the virtual gaming environment. The physical object 202 is manufactured from materials such as plastic, metal, or composite materials, and, in some embodiments, includes one or more visual elements that visually represent the corresponding virtual game element. For example, the physical object 202 is a miniature figurine of a character that players physically handle and position on the flat surface 104, and/or desire to represent virtually in the game map 106.

The NFC tag 204 is embedded within, attached to, or integrated with the physical object 202 to enable wireless communication with the mobile device 102. The NFC tag 204 includes an electronic circuit that includes an antenna and/or a microchip enabled to store data such as unique identifiers, character attributes, or authentication codes. The NFC tag 204 is positioned at the base, interior, or surface of the physical object 202 to enable detection by the mobile device's NFC reader when the physical object 202 is placed in proximity to the device 102. For example, the NFC tag 204 is embedded in a base platform beneath the physical object 202, allowing the tag to be read when the figurine is placed near the mobile device 102 on the flat surface 104.

The NFC-connected virtual object 206 represents the digital manifestation of the physical object 202 within the game map 106 displayed on the mobile device 102. The virtual object 206 appears as a character, item, or entity that mirrors the appearance and characteristics of the physical object 202. For example, if the physical object 202 is a warrior figurine, the NFC-connected virtual object 206 appears as an animated warrior character within the game map 106.

The system detects the NFC tag 204 when the NFC tag 204 is positioned within the operational range of the mobile device's NFC reader. The mobile device 102 continuously, manually, or periodically scans for NFC signals and establishes a communication link with the NFC tag 204 when the NFC tag 204 enters the detection range. The system determines a unique identifier from the detected NFC tag 204 by reading data stored within the tag's memory, which includes alphanumeric codes, hexadecimal values, or encrypted identifiers that distinguish the specific physical object 202 from other objects in the game system. The unique identifier, in some embodiments, includes additional metadata such as object type, version information, and so forth.

The system queries a database using the unique identifier to retrieve character data, where the database is stored locally on the mobile device 102, accessed through a network connection to remote servers, or distributed across multiple storage locations. The character data includes, in some embodiments, information about the virtual representation of the physical object 202, such as statistical attributes such as health points, attack power, defense ratings, or special abilities. The character data, includes, in some embodiments, visual properties such as 3D model files, texture maps, animation sequences, and so forth that define how the NFC-connected virtual object 206 appears and behaves within the game environment.

The system instantiates the corresponding NFC-connected virtual object 206 using the retrieved character data by creating a new instance of the virtual object within the game's memory space, loading the associated graphical assets, and/or positioning the object within the game map 106 at a location determined by game rules or player preferences. In some embodiments, the system supports multiple physical objects 202 simultaneously, each with its own NFC tag 204, enabling players to deploy multiple characters or items within the same gaming session. In some embodiments, the system updates the character data stored in the database based on gameplay achievements or progression, enabling the physical object 202 to retain persistent improvements or modifications across gaming sessions.

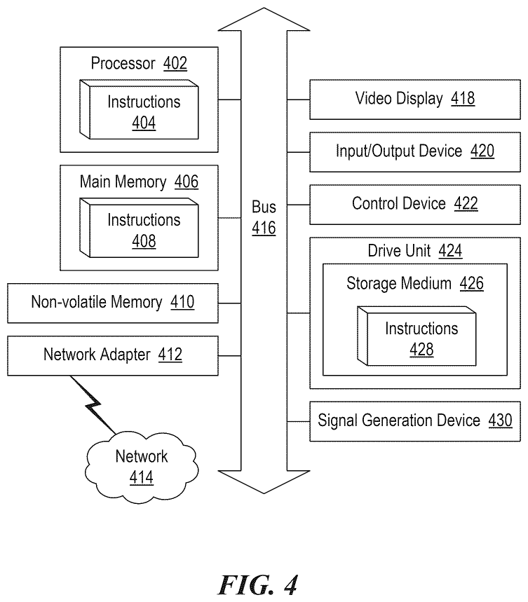

FIG. 3 is a flowchart illustrating a method 300 of detecting the translation of a mobile device during tabletop gameplay, in accordance with one or more embodiments. In some implementations, the method 300 is performed by components of example computer system 400 illustrated and described in more detail with reference to FIG. 4. Likewise, implementations can include different and/or additional steps or can perform the steps in different orders.

In step 302, the system provides a mobile device (e.g., device 102 in FIG. 1) with a velocity and a position on a flat surface (e.g., flat surface 104 in FIG. 1). In some embodiments, the mobile device includes a camera obstructed by contact with a flat surface when the mobile device is positioned flat against the flat surface. The mobile device displays a game map (e.g., game map 106) on a display screen of the device. Displaying the game map involves setting up the device in a known starting point, which acts as a reference for subsequent movement detection. For example, the initial velocity is zero, indicating that the device is stationary at the beginning of the gameplay session. Establishing a starting point allows the system to measure any changes in the position or movement of the device. For example, the system displays a visual marker or prompt on the screen of the device, guiding the user to position the device accurately. Once the device is in place, the system records the device's coordinates as the reference position to provide a consistent frame of reference. For instance, knowing which edge of the device is facing forward helps in distinguishing between movements to the left or right, forward or backward.

In some embodiments, during the initial setup, the system performs an initial calibration to account for any device-specific variations in sensor readings. Calibration is the process of adjusting sensor readings to account for device-specific differences, ensuring that the data accurately reflects real-world movements. Mobile devices from different manufacturers, or even different models from the same manufacturer, sometimes have variations in their sensors. The variations result in discrepancies in the sensor data, which result in erroneous measurements. Calibration involves adjusting the sensor outputs based on known reference points or standardized tests. For example, the system prompts the user to keep the device steady during the initial calibration while measuring the device's accelerometer and gyroscope to determine a token indicating the difference between the expected measurement (zero) and the actual measurement. In some embodiments, to indicate to the user that the user has correctly positioned the device, the system provides visual or auditory feedback. For example, once the device is correctly placed, a confirmation sound plays and/or a visual indicator turns green. The feedback helps the user to know that the device is ready for motion tracking.

In step 304, the system receives sensor data from one or more motion sensors of the mobile device. In some embodiments, the sensor data is received by a game application executing on the mobile device. The sensors include accelerometers and/or gyroscopes. Accelerometers measure linear acceleration along one or more axes (e.g., three orthogonal axes such as X, Y, and Z). Accelerometers detect changes in velocity over time, which allows the system to understand how fast and in which direction the device is moving (e.g., the speed and direction of slides of the device across the flat surface). Gyroscopes measure angular velocity, providing data about the device's rotation around its axes. Gyroscopes determine the orientation of the device and any rotational movements. In some embodiments, additional sensors such as magnetometers (which measure the device's orientation relative to the Earth's magnetic field) and proximity sensors (which detect the presence of nearby objects) are used to detect movement of the device. The raw sensor data is collected continuously as the device moves across the flat surface. Notably, a GPS sensor is typically not accurate to a precision of under 3 feet and the size of a play space (e.g., a flat surface 104) will not be large enough in most cases for the GPS to be functionally useful. Nevertheless, in some embodiments, the GPS is employed to provide further context for other available sensors to track the device's movement and derive linear motion data since a GPS provides real-world locations of the device.

In step 306, the system filters the sensor data to reduce noise and variability of the sensor data based on a set of predefined criteria that includes a frequency threshold, a magnitude threshold, or a time window, and so forth. Filtering is the process of smoothing out minor fluctuations and removing high-frequency noise from the sensor data. Raw sensor data often contains noise due to various factors such as electrical interference, environmental conditions, or minor vibrations. The noise obscures meaningful movement patterns and reduce the accuracy of motion detection. Filtering reduces random spikes and jitter in the data, which could otherwise lead to erratic or false movement detections. By reducing noise and variability, the system ensures that only meaningful movements (e.g., movement of the mobile device along a movement path on the flat surface) are captured and processed. For example, a low-pass filter is used to allow low-frequency signals (representing meaningful movements) to pass through while attenuating high-frequency noise. The result is a smoother data signal that more accurately represents the device's movements.

In some embodiments, to improve filtering, the system provides various adjustable parameters that are able to be tuned to improve sensor performance. Adjustable parameters, in some embodiments, are displayed on a graphical user interface (GUI). For example, motion speed is adjusted, which defines the pixel traversal speed across the digital image when the user moves the phone, with higher values resulting in faster image movement. In another example, a damping parameter (e.g., a deceleration coefficient) controls the deceleration rate after movement, with values ranging from 0 (instant stop) to 1 (no deceleration), helping to reduce bounce effects by providing a gradual deceleration. A motion threshold parameter determines the system's sensitivity to detected movements, with lower values detecting subtle movements, suitable for high-sensitivity applications, while higher values prevent responses to minor movements, stabilizing user interaction on platforms. A maximum acceleration parameter sets the upper limit for how quickly the system responds to rapid movements. For example, in some embodiments, the system limits the maximum acceleration (e.g., must be less than or equal to 12 units for user gameplay quality). A second gyroscope parameter measures the stabilization time of the gyroscope after movement to prevent misinterpreting stabilization as intentional movement. A low pass alpha parameter, which is a low-pass filter, smooths out sensor data, with a range from 0 (complete smoothness) to 1 (no smoothness), and typically set to middle values to avoid erratic or choppy behavior.

In some embodiments, an initial debounce delay parameter is used to indicate the initial waiting time before considering movement inputs valid after placing or moving the device, to prevent false detections. A minimum debounce delay parameter is the time before the system responds to continuous movements, ensuring new movements are detected accurately. A maximum debounce delay parameter is the maximum time before the system responds to very rapid movements, controlling the response to prevent system overload. For example, responsive to receiving the sensor data, the system buffers subsequent sensor data for a predetermined debounce period, and generates a subsequent set of pixel movements of the game map based on the subsequent sensor data subsequent to an expiration of the predetermined debounce period.

In step 308, the system evaluates the filtered sensor data to determine linear acceleration and angular velocity of the mobile device. The linear acceleration provides information about the changes in the device's speed and direction on the flat surface, while the angular velocity indicates the rotational movements.

In some embodiments, the system isolates the linear acceleration data from the accelerometer readings. The linear acceleration data reveals how quickly the device is speeding up or slowing down in different directions. The system then processes this data to calculate the velocity and positional changes of the device. For example, the system receives accelerometer data from the accelerometer indicating linear acceleration along three orthogonal axes: the X-axis representing horizontal acceleration in the left-right direction, the Y-axis representing horizontal acceleration in the forward-backward direction, and the Z-axis representing vertical acceleration in the up-down direction. The system decomposes the accelerometer data into horizontal acceleration components parallel to the flat surface, which include the X-axis and Y-axis measurements that capture translational movement across the table surface, and vertical acceleration components perpendicular to the flat surface, which include the Z-axis measurements representing movement away from or toward the table surface. The system calculates/determines a modified linear acceleration of the mobile device (and subsequently the set of pixel movements) based on the horizontal acceleration components by processing the X-axis and Y-axis data while filtering out the Z-axis data that does not contribute to movement across the flat surface.

Concurrently, the angular velocity data from the gyroscope is used to determine any rotational movements the device undergoes. The rotations indicate turns or tilts of the device. For example, in a game scenario, if the player moves the device rapidly to the left, the system detects this acceleration and updates the game map to show the player moving left. Similarly, if the player rotates the device, the system interprets the rotational data to adjust the game's perspective or orientation accordingly.

In some embodiments, the system evaluates the quality and accuracy of each sensor and prioritizes the sensor's usage or selects a subset of sensors when determining the linear acceleration and the angular velocity of the mobile device based on the evaluation. For example, the sensors are evaluated based on predefined criteria such as sensor accuracy, sensitivity, and responsiveness to determine the sensors' priority. Sensors that satisfy more criteria are assigned a higher priority level, while those that satisfy fewer criteria assigned a lower priority level. Cascading sensors by dynamically adjusting sensor usage based on device-specific characteristics allows the system to accommodate a wide range of mobile devices with varying sensor capabilities while ensuring consistent performance across different platforms. For example, if a particular sensor exhibits inconsistencies or inaccuracies under certain conditions, the system automatically switches to alternative sensors that provide more reliable data.

For example, while the selfie camera may not always be useful based on context (e.g., plain non-distinctive ceiling as opposed to a ceiling with clearly marked features), where the selfie camera does recognize ceiling elements, the system would employ data from the selfie camera to contextualize other available data. Where the default is not to employ the selfie camera, a configuration or orientation step identifies whether the selfie camera is detecting usable data and makes use of that data when able. To determine whether the selfie camera is detecting usable data, the system activates the selfie camera of the mobile device positioned to capture images of a ceiling above the flat surface. The system captures a sequence of images of the ceiling using the front-facing camera at regular intervals or continuously during device movement to monitor changes in the visual field (i.e., the ceiling) above. The system identifies a set of visual features within the captured images of the ceiling, such as light fixtures, ceiling tiles, architectural details, shadows, color variations, or distinctive patterns that operate as reference points for motion tracking.

In some embodiments, the system determines a feature density score based on the number of identifiable visual features per unit area of the captured images and the distribution of these visual features across the ceiling surface, with higher scores indicating more trackable elements. Responsive to the feature density score meeting or exceeding a predetermined threshold that indicates sufficient visual landmarks for reliable motion tracking, the system includes data defining the captured images in the filtered sensor data.

In some embodiments, when the one or more motion sensors include a rear-facing camera, the system determines that the rear-facing camera of the mobile device is obstructed by contact with the flat surface when the device is positioned flat against the table or other horizontal surface. The obstruction occurs, in some embodiments, because the rear-facing camera lens is pressed against or facing the flat surface, thus preventing the camera from capturing visual data indicative of movement of the mobile device. Responsive to determining that the rear-facing camera of the mobile device is obstructed, the system uses the sensor data from one or more motion sensors different from the rear-facing camera to determine the set of metric values of the mobile device. These alternative motion sensors include, for example, accelerometers, gyroscopes, magnetometers, the front-facing camera when ceiling features are detectable, thus enabling the system to accurately detect motion even when the rear-facing camera cannot function due to surface contact.

In step 310, the system translates the linear acceleration and the angular velocity of the mobile device to a set of pixel movements of the game map in accordance with the movement path of the mobile device. The system determines the appropriate pixel movements required to reflect the linear acceleration and the angular velocity of the mobile device on the game map. For instance, if the device experiences a sudden increase in linear acceleration along the x-axis, indicative of movement to the right, the system calculates the corresponding number of pixels by which the game map on the screen of the device shifts in the opposite direction.

Similarly, the system translates rotational movements experienced by the device into adjustments in the orientation of the game map. For example, if the device experiences a clockwise rotation, the system calculates the necessary pixel adjustments to rotate the contents (e.g., the pixels indicating an interactive object 108, the pixels indicating the map terrain) of the game map accordingly, ensuring that the user's perspective within the virtual environment remains aligned with their physical movements. For example, the system determines a rotation matrix based on a rotational motion of the mobile device detected using a gyroscope coupled to the mobile device. The system rotates the game map and characters/objects within by applying the rotation matrix to coordinates of the game map and the characters/objects within. The system is enabled to update the display of the game map on the mobile device to display the rotated game map and the rotated characters/objects.

In step 312, the system displays the set of pixel movements of the game map on the mobile device. For example, the system updates the display of the game map on the mobile device in accordance with the set of pixel movements to display a second portion of the game map different from the first portion of the game map. The system uses the calculated set of pixel movements in step 310 to update the game map's position and orientation accordingly. In some embodiments, the system calculates a velocity vector based on the movement path. The system compares a magnitude of the velocity vector to a predefined speed threshold, and selects a rendering resolution based on comparing the magnitude of the velocity vector to the predefined speed threshold. The system is enabled to update the display of the game map on the mobile device in accordance with the selected rendering resolution. For example, the system adjusts the level of detail for game map elements, displays simplified versions of complex objects, and/or reduces the draw distance for distant elements. Additionally, the system is enabled to modify the refresh rate or frame rate of the display depending on the selected rendering resolution.

In some embodiments, the system adjusts a position or state vector (e.g., a game state) of at least one interactive object represented within the game map in response to the updated display of the game map. The state vector refers to a data structure that indicates a condition of an interactive object within the game environment. The state vector includes, in some embodiments, positional information such as x, y, and z coordinates, orientation data including rotation angles, velocity and acceleration components, display attributes, and/or various object-specific attributes such as health points, energy levels, animation states, collision boundaries, visibility flags, or interaction capabilities. In some embodiments, the state vector includes temporal information such as timestamps for state changes, duration counters for temporary effects, progression markers for ongoing animations, and so forth. In some cases, the state vector indicates references to associated game assets, behavioral parameters, or relationships (e.g., spatial or contextual) with other interactive objects.

For example, the system adjusts the position of game elements, such as the player's avatar (e.g., an avatar corresponding to an NFC tag a player scans in) or environmental objects (e.g., game interactive object 108), based on the calculated pixel shifts. For instance, if the user moves the mobile device to the right, the system updates the game map by shifting all elements to the left to simulate the device's motion across the flat surface. In some embodiments, the system redraws the game map and its elements in their new positions based on the updated set of pixel movements.

In some embodiments, the system accesses a set of game rules defining one or more parameters for at least one interactive object. The system is enabled to apply the one or more parameters to the movement path, and determine the new position of at least one interactive object based on the applied one or more parameters. The game rules are stored in a configuration file, database, and/or embedded within the game application code, and include one or more behavioral parameters that govern how interactive objects respond to device movement and environmental conditions. These parameters include, for example, movement constraints such as maximum velocity limits, acceleration boundaries, or directional restrictions that prevent objects from moving beyond designated areas of the game map. The parameters include, in some embodiments, physics-based properties such as mass, friction coefficients, elasticity values, or gravitational effects that indicate how objects interact with the virtual environment and respond to forces applied through device movement.

In some embodiments, the parameters define interaction rules that specify how objects behave when encountering other game elements, including collision detection boundaries, proximity triggers, or state transition conditions. For example, the parameters trigger one or more visual and audio properties such as animation sequences, particle effects, sound triggers, or lighting modifications that activate based on object movement or position changes. Additionally, the parameters in some embodiments include gameplay mechanics such as scoring multipliers, power-up effects, damage calculations, or resource consumption rates that are influenced by the object's movement patterns or current location within the game map. The system, in some embodiments, implements conditional logic that selectively applies different parameter sets based on current game state, object type, or environmental factors.

When the system detects a user input on a display screen of the mobile device at the new position of at least one interactive object, the system determines an interaction type based on the detected user input. The system is enabled to modifying one or more parameters of at least one interactive object based on the determined interaction type and update the display to reflect the modified one or more parameters.

In some embodiments, the system segments the game map into multiple depth layers, and assigns movement coefficients to each depth layer. The system determines a respective offset value for each depth layer based on the movement path and corresponding movement coefficients, and instructs a controller to render each depth layer in accordance with the respective offset value.

### Computer System

FIG. 4 is a block diagram that illustrates an example of a computer system 400 in which at least some operations described herein can be implemented. As shown, the computer system 400 can include: one or more processors 402, main memory 406, non-volatile memory 410, a network interface device 412, a video display device 418, an input/output device 420, a control device 422 (e.g., keyboard and pointing device), a drive unit 424 that includes a machine-readable (storage) medium 426, and a signal generation device 430 that are communicatively connected to a bus 416. The bus 416 represents one or more physical buses and/or point-to-point connections that are connected by appropriate bridges, adapters, or controllers. Various common components (e.g., cache memory) are omitted from FIG. 4 for brevity. Instead, the computer system 400 is intended to illustrate a hardware device on which components illustrated or described relative to the examples of the figures and any other components described in the specification can be implemented.

The computer system 400 can take any suitable physical form. For example, the computing system 400 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 400. In some implementations, the computer system 400 can be an embedded computer system, a system-on-chip (SOC), a single-board computer system (SBC), or a distributed system such as a mesh of computer systems, or it can include one or more cloud components in one or more networks. Where appropriate, one or more computer systems 400 can perform operations in real time, in near real time, or in batch mode.

The network interface device 412 enables the computing system 400 to mediate data in a network 414 with an entity that is external to the computing system 400 through any communication protocol supported by the computing system 400 and the external entity. Examples of the network interface device 412 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 406, non-volatile memory 410, machine-readable medium 426) can be local, remote, or distributed. Although shown as a single medium, the machine-readable medium 426 can include multiple media (e.g., a centralized/distributed database and/or associated caches and servers) that store one or more sets of instructions 428. The machine-readable medium 426 can include any medium that is capable of storing, encoding, or carrying a set of instructions for execution by the computing system 400. The machine-readable medium 426 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite the change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 410, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 404, 408, 428) set at various times in various memory and storage devices in computing device(s). When read and executed by the processor 402, the instruction(s) cause the computing system 400 to perform operations to execute elements involving the various aspects of the disclosure.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations can perform routines having steps, or employ systems having blocks, in a different order, and some processes or blocks can be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples: alternative implementations can employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, specific terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112 (f) will begin with the words “means for,” but use of the term “for” in any other context is not intended to invoke treatment under 35 U.S.C. § 112 (f). Accordingly, the applicant reserves the right to pursue additional claims after filing this application to pursue such additional claim forms, in either this application or in a continuing application.

We claim:

1. A computer-implemented method for updating a game map display during tabletop gameplay, the computer-implemented method comprising:
receiving, by a game application executing on a mobile device which includes a camera obstructed by contact with a flat surface when the mobile device is positioned flat against the flat surface, sensor data from one or more motion sensors of the mobile device, wherein the game application displays a first portion of a game map on the mobile device;
filtering the sensor data based on a set of predefined criteria that includes at least one of: (a) a frequency threshold, (b) a magnitude threshold, or (c) a time window, wherein the filtered sensor data indicates movement of the mobile device along a movement path on the flat surface;
based on the filtered sensor data, determining a set of metric values of the mobile device that defines (a) a linear acceleration and (b) an angular velocity of the mobile device relative to the flat surface;
translating the set of metric values of the mobile device to a set of pixel movements of the game map in accordance with the movement path of the mobile device; and
updating the display of the game map on the mobile device in accordance with the set of pixel movements to display a second portion of the game map different from the first portion of the game map.

2. The computer-implemented method of claim 1, further comprising:
adjusting a position or state vector of at least one interactive object represented within the game map in response to the updated display of the game map.

3. The computer-implemented method of claim 1, further comprising:
selecting a subset of motion sensors based on a predefined weight assigned to each motion sensor; and
determining the set of metric values using data received from the selected subset of motion sensors.

4. The computer-implemented method of claim 1, further comprising:
applying a deceleration coefficient to the set of metric values.

5. The computer-implemented method of claim 1, further comprising:
comparing respective magnitudes of the set of metric values to a predefined movement threshold; and
discarding one or more metric values with a respective magnitude failing to satisfy the predefined movement threshold.

6. The computer-implemented method of claim 1, further comprising:
defining an acceleration threshold; and
discarding one or more metric values indicative of an acceleration failing to satisfy the acceleration threshold.

7. The computer-implemented method of claim 1, further comprising:
responsive to receiving the sensor data, buffering subsequent sensor data for a predetermined debounce period; and
generating a subsequent set of pixel movements of the game map based on the subsequent sensor data subsequent to an expiration of the predetermined debounce period.

8. A computer-implemented method for updating a game map display during tabletop gameplay, the computer-implemented method comprising:
displaying, by a game application executing on a mobile device which includes a camera obstructed by contact with a flat surface, a first portion of a game map representing at least one interactive object in an initial position;
receiving, by the game application, sensor data from one or more motion sensors of the mobile device representing movement of the mobile device along a movement path on the flat surface;
generating a set of pixel movements of the game map in accordance with the movement path, wherein the set of pixel movements is configured to be applied on the first portion of the game map to display a second portion of the game map different from the first portion;
determining a new position of the at least one interactive object represented within the second portion of the game map, wherein the new position of the at least one interactive object relative to the movement path simulates a perspective change in the game map; and
updating the display of the game map on the mobile device in accordance with the set of pixel movements to display the second portion of the game map and the at least one interactive object positioned at the new position.

9. The computer-implemented method of claim 8, wherein the one or more motion sensors include an accelerometer, the method further comprising:
receiving accelerometer data from the accelerometer indicating linear acceleration of the mobile device along three orthogonal axes;
decomposing the accelerometer data into (a) horizontal acceleration components parallel to the flat surface and (b) vertical acceleration components perpendicular to the flat surface; and
determining the set of pixel movements based on the horizontal acceleration components.

10. The computer-implemented method of claim 8, further comprising:
accessing a set of game rules defining one or more parameters for the at least one interactive object;
applying the one or more parameters to the movement path; and
determining the new position of the at least one interactive object based on the applied one or more parameters.

11. The computer-implemented method of claim 8, further comprising:
detecting a user input on a display screen of the mobile device at the new position of the at least one interactive object;
determining an interaction type based on the detected user input;
modifying one or more parameters of the at least one interactive object based on the determined interaction type; and
updating the display in accordance with the modified one or more parameters.

12. The computer-implemented method of claim 8, further comprising:
determining a rotation matrix based on a rotational motion of the mobile device detected using a gyroscope coupled to the mobile device;
rotating the game map and the at least one interactive object by applying the rotation matrix to coordinates of the game map and the at least one interactive object; and
updating the display of the game map on the mobile device to display the rotated game map and the rotated at least one interactive object.

13. The computer-implemented method of claim 8, further comprising:
calculating a velocity vector based on the movement path;
comparing a magnitude of the velocity vector to a predefined speed threshold;
selecting a rendering resolution based on comparing the magnitude of the velocity vector to the predefined speed threshold; and
updating the display of the game map on the mobile device in accordance with the selected rendering resolution.

14. The computer-implemented method of claim 8, further comprising:
detecting an Near Field Communication (NFC) tag in proximity to the mobile device;
determining a unique identifier from the detected NFC tag;
querying a database using the unique identifier to retrieve character data; and
instantiating the at least one interactive object using the character data.

15. A game application executable on a mobile device which includes a camera obstructed by contact with a flat surface, the game application comprising:
a communication interface of the game application configured to receive sensor data from one or more motion sensors of the mobile device, wherein the game application displays a first portion of a game map on the mobile device;
a processor communicatively coupled to the communication interface, the processor configured to:
apply a set of predefined criteria to the sensor data to output filtered sensor data defined by a set of metric values that defines (a) a linear acceleration and (b) an angular velocity of the mobile device relative to the flat surface along a movement path, and
translate the set of metric values to a set of pixel movements of the game map in accordance with the movement path; and
a controller communicatively coupled to the processor, the controller configured to update the display of the game map on the mobile device in accordance with the set of pixel movements, wherein the update causes the display to change from presenting the first portion of the game map to presenting a second portion of the game map different from the first portion.

16. The game application of claim 15, wherein the processor is further configured to:
maintain a state machine for each interactive object within the game map,
update the state machine based on the set of pixel movements,
calculate new display attributes for each interactive object based on the updated state machine, and
instruct the controller to render each interactive object with the new display attributes.

17. The game application of claim 15, wherein the camera is a rear-facing camera, wherein the processor is further configured to:
use the sensor data from one or more motion sensors different from the rear-facing camera to determine the set of metric values of the mobile device.

18. The game application of claim 15, wherein the one or more motion sensors include a front-facing camera, and wherein the processor is further configured to:
cause activation of the front-facing camera of the mobile device positioned to capture images of a ceiling above the flat surface;
cause capture of a sequence of images of the ceiling using the front-facing camera;
identify a set of visual features within the captured images of the ceiling;
determine a feature density score based on any of a number or a distribution of the set of visual features within the captured images of the ceiling; and
responsive to the feature density score to a predetermined threshold, include data defining the captured images in the filtered sensor data.

19. The game application of claim 15, wherein the processor is further configured to:
determine a set of character attributes associated with NFC tag data received by the processor; and
spawn an interactive object within the game map in accordance with the set of character attributes.

20. The game application of claim 15, wherein the processor is further configured to:
update a position of one or more objects represented within the first portion of the game map based on the set of pixel movements.
